(19) United States
(12) Patent Application Publication
(10) Pub. No.: US 2013/0320024 A1
(43) Pub. Date: Dec. 5, 2013

(54) Heating Article Comprising a Non-Stick Coating with a Three-Dimensional Decoration

(71) Applicants: Jean-Luc Perillon, Saint Paul Trois Chateaux (FR); Michel Fontaine, Sales (FR); Clotilde Baldeck, La Ravoire (FR)

(72) Inventors: Jean-Luc Perillon, Saint Paul Trois Chateaux (FR); Michel Fontaine, Sales (FR); Clotilde Baldeck, La Ravoire (FR)

(73) Assignee: SEB S.A., Ecully (FR)

(21) Appl. No.: 13/985,405

(22) PCT Filed: Feb. 20, 2012
(86) PCT No.: PCT/FR2012/050362

§ 371 Date: Aug. 14, 2013

(30) Foreign Application Priority Data
Feb. 18, 2011 (FR) 1151375

(51) Int. Cl. A47J 36/02

(52) U.S. Cl. CPC A47J 36/025
USPC 220/573.2; 427/550

(57) ABSTRACT

Provided is a heating utensil comprising a support intended to be heated, said support comprising a surface covered by a non-stick coating, said non-stick coating comprising at least one sintered layer based on fluorocarbon resin forming a continuous network. Said sintered layer additionally comprises a mixture of magnetizable particles and of non-magnetizable particles, some of said magnetizable particles being oriented so as to form a three-dimensional pattern. Also provided is a method for producing such a heating utensil.

The present invention relates to a heating article comprising a surface covered by a non-stick coating comprising a three-dimensional decoration, and a method of manufacturing such a heating article.

The invention more particularly relates to heating culinary articles such as pans, pots, or frying pans, for example.

The invention also has other applications in the field of plancha grills, deck ovens, iron sole plates, electric cooking equipment (griddle plates, table grills, raclettes for example).

The heating culinary articles generally comprise a support intended to be heated. This support comprises an inner surface covered by a non-stick coating, which may typically be a coating comprising at least one fluorocarbon resin-based sintered layer forming a continuous network

Cooking food inside culinary articles that are coated with such a non-stick coating layer has many advantages such as reducing the quantity of fat used, and easier cleaning, implying a saving of time and surfactant products used for cleaning the surface of the culinary article.

To form a decoration on the inside surfaces of these culinary articles comprising such a non-stick coating (that is to say, sintered fluorocarbon resin base forming a continuous network), it is known by the skilled person to either place the decoration at the surface of the non-stick coating, or to place it between the layers that constitute it. Such a decoration is generally colored (with one or several colors) and comprises patterns which can be continuous or discontinuous.

In order to obtain a three-dimensional decoration, it is known French patent FR 1440147 by TEFAL, which relates to a three-dimensional (3D) method of decorating inside a translucent plastic material. More particularly, this document describes a method making it possible to obtain a decoration in an industrial manner by incorporating lamellar ferromagnetic fillers in the translucent plastic material. These lamellar ferromagnetic fillers are subjected to a fixed magnetic constraint field such as to form a 3D decoration.

It is also known international applications WO° 2006/066027 and WO 00/12622 filed by Dupont de Nemours, which describe the use of metal particles (particularly stainless steel) in the prime (“primer”) or intermediary (“Midcoat”) layers covering an article. The metal particles affect the thermal conductivity in the article according to their orientation. However, the decorations described in applications WO° 2006/066027, and WO 00/12622 do not make it possible to obtain a sufficient relief effect due to the uniform distribution of magnetizable particles. Furthermore, the obtained decoration is monochrome, which affects the differentiation possibilities expected for a decoration.

Moreover, international application WO 99/12662 of DuPont de Nemours describes a method for obtaining a three-dimensional decoration on a culinary article wherein the intermediary layer in polytetrafluoroethylene (PTFE) includes metallic particles. These decorations may be constituted of one or more patterns, and are obtained by means of one single magnet or electromagnet. However, such PTFE layers comprising metallic particles oriented by a magnetic field such as to form a three-dimensional decoration exhibit reduced non-stick properties with respect to the same PTFE layers without metal particles.

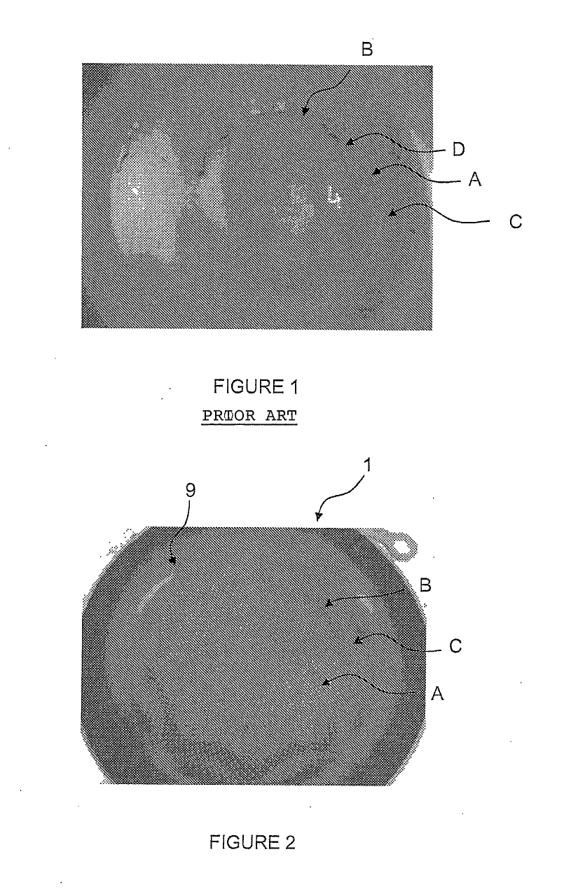

More particularly, the culinary article coated by such a layer exhibit a non-stick surface having inhomogeneous non-stick properties, with areas A wherein the non-stick properties are good, and areas B wherein the non-stick properties are less good, as represented on FIG. 1. In fact, this fig. particularly represents a frying pan of the prior art comprising a PTFE based non-stick layer and metallic particles oriented by a magnetic field to form a decoration C.

In FIG. 1, are distinguished:
areas A which correspond to areas for which the lines of the magnetic field applied for the formation of the decoration are parallel with the surface of the support, and
areas B, which correspond to areas for which the lines of the magnetic field applied for the formation of the decoration are substantially perpendicular to the surface of the support, such that the magnetizable particles are consequently oriented substantially perpendicular to the surface of the support.

Areas B are located at the level of the magnets that have been used to form the decoration (stronger magnetization). It is observed that at the level of these areas B, the non-stick properties are less good, leading to the food D attaching during cooking in the culinary article.

Furthermore, the method for producing a 3D decoration proposed in application WO 99/12662 only makes it possible to obtain monochrome decorations.

It is also known by the skilled person American application US 2007/0237891, which generally discloses a device and method for forming three-dimensional colored patterns in a coating film covering an article.

The coating composition to form the coating film comprises a thermoplastic resin dissolved in solvents, magnetizable particles in flake form, dyes or pigments, which may be of organic, metallic (in powdered form) or even photoluminescent (for example mica) nature, a cross-linking agent (for example, amine, epoxy or polycarbodiimide resins, or isocyanate-based compounds), and other types of additives, such as antioxidants, anti-foaming agents, thickeners, UV absorbers, and leveling agents.

In order to obtain the coating film, the composition is solidified by solvent evaporation, without curing.

A coating film having a homogenous color effect on the entire 3D pattern is obtained.

However, the coating film obtained with this method of the prior art does not makes it possible to obtain a layer of sintered fluorocarbon resin based non-stick coating forming a continuous network, having at the same time a clearly visible three-dimensional colored decoration with very good non-stick properties.

In fact, the purpose of document US 2007/0237891 is not to improve the non-stick property of a coating but simply to obtain a coating having a homogenous color effect on the entire 3D pattern.

Hence, the purpose of the present is to provide a heating article that overcomes these drawbacks.

By heating article, is meant according to the present invention, an article which has its own heating system, or which is heated by an external system that is able to transmit the calorific energy provided by this system to a material or third object in contact with said article.

More particularly, the present invention relates to a heating article comprising a support intended to be heated. This support comprises a surface covered by a non-stick coating comprising at least a sintered fluorocarbon resin-based layer forming a continuous network.

According to the invention, the sintered fluorocarbon resin-based layer further comprises a mixture of magnetizable particles and non magnetizable particles, part of said magnetizable particles being inclined at an angle α with respect to the support surface, and the other magnetizable particles being substantially parallel with the support such as to form a three-dimensional decoration.

By sintered fluorocarbon resin based layer is meant, according to the present invention, a layer of fluorocarbon resin in particulate form before sintering and forming a continuous network after sintering.

By non-magnetizable particles is meant according to the present invention non-magnetizable or weakly magnetizable particles having a null or low magnetic moment (less than 1 uem/g).

By 3D decoration or colored hologram, is meant a decoration making it possible to obtain a deep 3D visual effect.

The heating article according to the invention comprises a non-stick coating which maintains good non-stick properties after application of a magnetic field on the magnetizable particles to form a colored 3D decoration, as represented on FIG. 2 The application of the 3D decoration does not modify the non-stick properties of the coating.

More particularly, the invention makes it possible to obtain a non-stick coating exhibiting homogeneous non-stick properties over its entire surface, whereof the areas B have good non-stick properties.

The result obtained by the invention is surprising because it is generally accepted by the skilled person that the introduction of fillers (particles or flakes or other) in a sintered fluorocarbon resin based coating, particularly PTFE, leads to a decrease of the non-stick properties of this coating. It is also known that the more charges added, the greater the decrease of non-stick properties.

However, the applicant has surprisingly discovered that the presence of non-magnetizable particles in the same coating layer as that containing the magnetizable particles influences the formation of the 3D decoration and distribution of the fluorocarbon resin.

Thus, in areas B such as illustrated on FIG. 2, the non-stick coating has a superficial thickness of fluorocarbon resin identical or nearly so to that observed in areas A having no decoration, without the magnetizable particles protruding. The fluorocarbon resin is thus spread uniformly over the entire surface of the support, forming a substantially smooth superficial layer.

As regards the formation of the 3D decoration, the presence of non-magnetizable particles in the same coating layer as that containing the magnetizable particles influences the inclination of the magnetizable particles in areas B where the lines of the magnetic field are perpendicular with the support. The non-magnetizable particles are interposed between the magnetizable particles and the fluorocarbon particles. The orientation of the magnetizable particles may not be strictly perpendicular with the support due to the non-magnetizable particles taking up the space. The magnetizable particles are inclined at an angle α) with respect to the support surface of the culinary article. This angle α is advantageously comprised between 20° and 89°. It is preferably comprised between 45° and 89°.

The detachment of the magnetizable particles is hindered and the covering by the fluorocarbon resin is facilitated. The inclined magnetizable particles are thus covered by a thickness of fluorocarbon resin that is more important and sufficient to ensure good anti-adhesion. The magnetizable particles thus no longer protrude from the surface of the non-stick coating.

The introduction of the non-magnetizable particles, although it slightly reduces the visual contrast between areas A and B, as represented on FIG. 2, does not affect the decoration definition.

With respect to the solution of the prior art to increase the non-stick property consisting in adding a top layer of fluorocarbon resin (particularly PTFE) on the layer of fluorocarbon resin comprising magnetizable particles, the solution proposed by the invention also has the advantages of being less expensive and providing a more abrasion-resistant non-stick layer over time without affecting the visibility of the decoration. The risk of the final layer of PTFE turning yellow and the lack of transparency is also prevented.

Furthermore, with respect to the solution of the prior art to increase the non-stick property consisting in modifying the distance between the magnet and the magnetizable particles, the solution proposed by the present invention also has the advantage of being implemented industrially more easily. In fact, changing the distance between the magnet and the magnetizable particles is difficult to implement from an industrial point of view due to the variety of thicknesses of the proposed culinary articles, as it would require many adjustments that would harm productivity.

Furthermore, the presence of non-magnetizable particles allows for a better wetting of the fluorocarbon resin.

The present invention also relates to a method for manufacturing a heating article comprising the following steps:
preparing at least a composition based on at least one fluorocarbon resin in thermally stable particulate form and resistant to at least 200° C., said fluorocarbon resin, being either alone or mixed with a thermally stable bonding resin and resistant to at least 200° C.,
applying said composition on a surface of said support to form a fluorocarbon resin;
curing said heating article thus coated with said fluorocarbon resin layer comprising a three dimensional decoration at a temperature ranging between 350° C. and 450° C. to sinter said layer such as to obtain a sintered fluorocarbon resin based layer forming a continuous network.

According to the invention, the composition based on fluorocarbon resin further comprises a mixture of magnetizable particles and non-magnetizable particles, and a magnetic field being applied in the fluorocarbon resin layer, before the curing step, such as to orient the magnetic particles to form a three dimensional decoration in said layer.

Advantageously, the magnetic field may be applied after the step of applying the fluorocarbon resin based composition and before the curing step.

In the case of a non-stick coating with at least two layers (in this case a layer of primer base and a finishing layer), the method comprises the following steps:
preparing a composition of primer base based on at least one fluorocarbon resin in particulate form, in a mixture with at least one thermally stable bonding resin resistant to at least 200° C.;
preparing a fluorocarbon resin based finishing composition in particulate form and resistant to at least 200° C., said fluorocarbon resin, being either alone or in a mixture with at least another thermally stable fluorocarbon resin resistant to at least 200° C., and further comprising a mixture of magnetizable particles and non-magnetizable particles;
applying said primer composition on a surface of said support to form a layer of primer base;
applying said finishing composition on said primer composition to form a finishing layer;
applying a magnetic field in the finishing layer, such as to orient the magnetic particles to form a three dimensional decoration in said layer; and
curing said coated article at a temperature ranging between 350° C. and 450° C. to sinter said primer and finishing layers.

Advantageously, the fluorocarbon particles of the fluorocarbon resin based composition exhibit a dimension less than or equal to 5 μm, and preferably ranging between 90 nm and 300 nm, this particle size making it possible to realize particularly dense films.

The fluorocarbon resin is advantageously selected from among polytetrafluoroethylene (PTFE), copolymer of tetrafluoroethylene and perfluoro propyl vinyl ether (PFA), and the copolymer of tetrafluoroethylene and hexafluoropropylene (FEP), and combinations thereof.

Other heat-stable resins resistant to at least 200° C. may be a polyamide-imid (PAI), a polyethersulfone (PES), polyphenylene sulfide (PPS), polyetherketone (PEK), polyetheretherketone (PEEK) or silicone.

Other advantages and features of the present invention will result from the following description given by way of non-limiting example and made with reference to the accompanying drawings:

FIG. 1 represents a photograph of a frying pan of the prior art;

FIG. 2 represents a photograph of a frying pan obtained according to an embodiment of the invention;

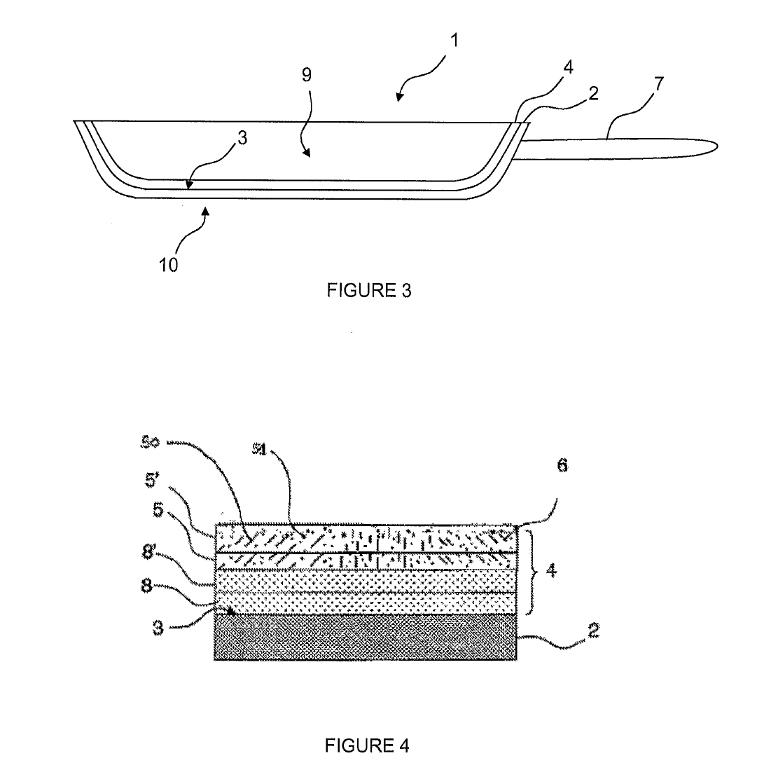

FIG. 3 represents a schematic view of a frying pan obtained according to an embodiment of the invention;

FIG. 4 represents a cross-sectional schematic view of this frying pan;

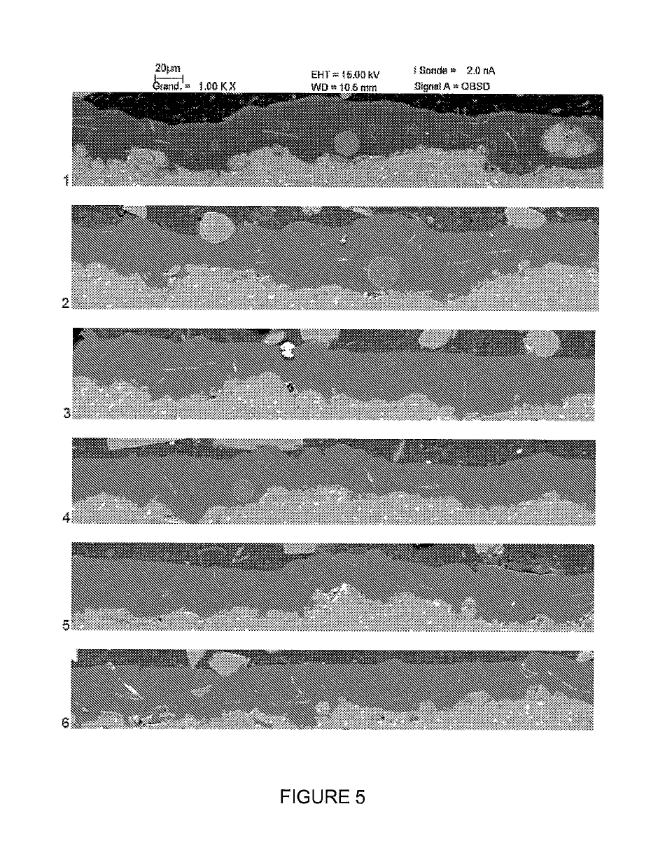

FIG. 5 represents a series of six images 5.1 to 5.6 of scanning electron microscopy (SEM) of a cross-section of the frying pan illustrated on FIG. 3 realized at an area B where the lines of the magnetic field are perpendicular to the support;

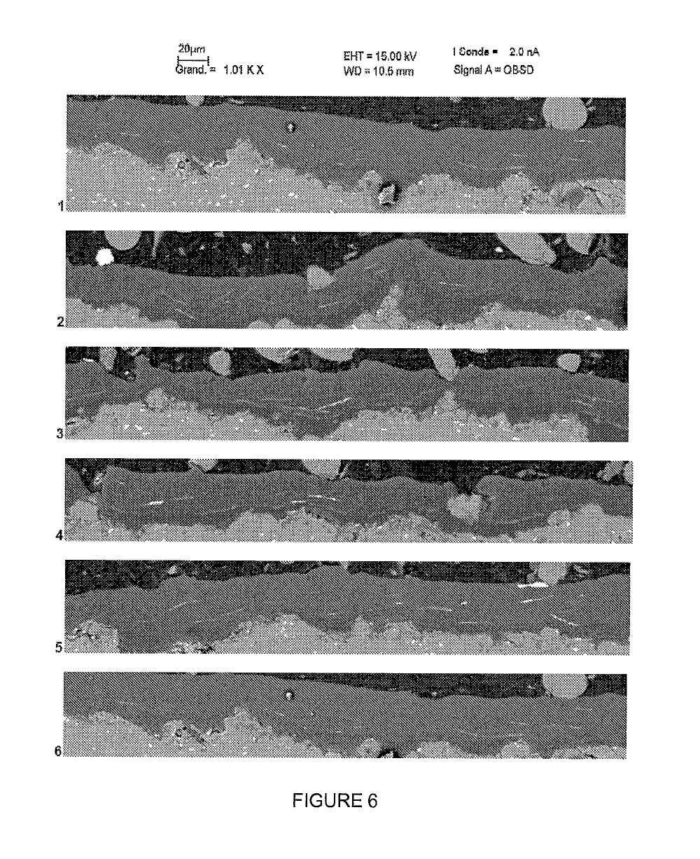

FIG. 6 represents a series of six images 6.1 to 6.2 of scanning electron microscopy (SEM) of a cross-section of the frying pan illustrated on FIG. 3 realized at an area A where the lines of the magnetic field are parallel with the support.

FIGS. 1 and 2 have been previously commented in the introductory and descriptive parts of the present invention.

On FIG. 3 is represented by way of example of culinary article according to the invention, a frying pan 1 comprising a support 2 in the form of a hollow bowl and a gripping handle 7. The support 2 comprises an inner side 9 which is the side facing the food liable to be received in the frying pan 1, and an outer side 10 which is intended to be disposed towards an external heat source.

FIG. 4 represents a detailed transversal cross section of the frying pan 1. The support 2 is intended to be heated and comprises, on its inner side 9, a surface 3 covered by a non-stick coating 4 comprising at least a fluorocarbon resin based sintered layer 5, 5′ forming a continuous network. The final non-stick coating 4 is obtained after curing. The fluorocarbon resin which is semi-crystalline is thus in the form of particles bonded to each other by forming a continuous sintered network.

The total thickness of the layer 5, 5′ of sintered fluorocarbon resin may range between 18 and 32 μm, but advantageously ranges between 21 and 27 μm, and better still of the order of 23 μm. This thickness is moreover only very rarely below 18 μm.

The sintered fluorocarbon resin based layer 5, 5′ further comprises a mixture of magnetizable particles 50 and non-magnetizable particles 51.

The mixture of magnetizable particles 50 and non-magnetizable particles 51 represents between 1% and 5% in weight by weight of the fluorocarbon resin based sintered layer 5, 5′. This distribution makes it possible to obtain good non-stick properties.

Preferably, the mixture of magnetizable particles 50 and non-magnetizable particles 51 represents between 2% and 3% in weight by weight of the sintered fluorocarbon resin based layer, thereby further improving the non-stick properties of the coating.

The percentage of non-magnetizable particles 51 in the mixture 50 of magnetizable particles and non magnetizable particles 51 ranges between 15% and 40% in weight with respect to the total weight of the mixture of magnetizable particles and non-magnetizable particles.

The non-magnetizable particles 51 serve on the one hand to disrupt the orientation of the magnetizable particles 50 in areas of high field and on the other hand to provide additional color.

An overly high content in non-magnetizable particles 51, higher than 40% in weight of the total weight of the mixture of magnetizable and non-magnetizable particles, leads to a three-dimensional effect lacking in visibility. A too low content less than 15% in weight of the total weight of the mixture of magnetizable and non-magnetizable particles does not make it possible to ensure the uniformity of the anti-adhesion.

Preferably, the mixture of magnetizable particles and non-magnetizable particles comprises ⅓ non-magnetizable particles, and ⅔ magnetizable particles. Thus, the best compromise is achieved between the definition of decoration and the homogeneous non-stick performances.

The non-magnetizable particles 51 are characterized by their size (D90) ranging between 20 and 250% of the dimension (D90) of magnetizable particles 50.

By the term “D90” is meant, according to the present invention, the maximum dimension of 90% of the particles.

These dimensions and concentrations of non-magnetizable particles make it possible to obtain a decoration C in three high-contrast dimensions, as represented on FIG. 2, and a homogeneous anti-adherence over the entire surface of the non-stick coating 4.

The choice of dimension of the non-magnetizable particles 51 is the result of a compromise. If they are too small, they do not make it possible to sufficiently influence the orientation of the magnetizable particles to improve the anti-adhesion. If the non-magnetizable particles are too large, they become too bulging, and hinder the migration mechanism of the fluorocarbon resin particles that improves the anti-adhesion.

Preferably, the magnetizable particles 50 have a dimension D50 less than or equal to 23 μm.

By the term “D50” is meant, according to the present invention, the maximum dimension of 50% of the particles.

Preferably, the non magnetizable particles 51 have a dimension D90 less than or equal to 60 μm. A size greater than this value does not facilitate the insertion of the non-magnetizable particles 51 in the film: in fact, they can harm the anti-adhesion due to their protuberance.

The magnetizable particles 50 and non-magnetizable particles 51 are advantageously in the form of flakes, that is to say in a substantially flat and elongated shape.

The non-magnetizable particles 51 may also have various shapes such as a spherical or ovoid shape, for example. They may have a regular or irregular shape.

The non-magnetizable particles 51 may be made of mica, aluminum or mica coated with titanium dioxide (Iriodin® 100, Iriodin® 111 and Iriodin® 153 by “Merck” for example).

The magnetizable particles 50 may be constituted of ceramic particles coated with a ferromagnetic material.

Particularly, the magnetizable particles 50 may be iron particles with a D50 of the order of 18 μm and a diameter D90 of the order of 28 μm (for example the particles commercialized by the Eckart company under trade name STAPA®TA FERRICON 200) or iron oxide particles (preferably with ferritic iron) or even mica or iron oxide Fe₃O₄ particles (for example the particles commercialized by the Merck company under trade name COLORONA® BLACKSTAR BLUE having a diameter D50 of 18 to 23 μm and a D90 of 43 μm).

The surface of the magnetizable and/or non-magnetizable particles is colored.

By surface coloration of a particle is meant according to the present invention, a coloring in visible mass on the surface or a coating that gives color to the particle.

Advantageously, the magnetizable and/or non-magnetizable particles have a core-shell structure, wherein the shell achieved in one or several layers brings color by either absorption or by interferometry.

By way of example of magnetizable particles 50 with a core-shell structure, it may be particularly mentioned mica particles coated with iron oxide (ferrite).

By way of example of non-magnetizable particles 51 with a core-shell structure, it may be particularly mentioned mica particles coated with TiO₂.

The association of magnetizable ceramic particles and non-magnetizable colored particles makes it possible to obtain a wide range of colors for decorations, while providing homogeneous anti-adhesion over the entire surface of the non-stick coating 4.

The non-magnetizable colored particles provide new color possibilities.

The fluorocarbon resin based sintered layer 5, 5′ may comprise one single fluorocarbon resin or a mixture of fluorocarbon resins, alone or in a mixture with other heat stable resins.

The fluorocarbon resin is such as defined above, that is to say, that it may advantageously be selected from among polytetrafluoroethylene (PTFE), copolymer of tetrafluoroethylene and perfluoro propyl vinyl ether (PFA), and copolymer tetrafluoroethylene and hexafluoropropylene (FEP), and combinations thereof.

The other heat stable resins resistant to at least 200° C. are also as defined above, that is to say they can be a polyamide-imide (PAI), polyethersulfone (PES), polyphenylene sulfide (PPS), a polyetherketone (PEK), polyetheretherketone (PEEK) or a silicone.

The support 2 may be metallic, ceramic, glass, or plastic.

The support 2 may be made of aluminum and aluminum alloy, anodized or not, in ferritic or austenitic stainless steel, iron or copper. The support 2 can be achieved with a combination of these aforementioned materials for all or part of its surface.

Surprisingly, the support 2 can be realized in magnetizable metals (for example in ferritic stainless steel).

The 3D decoration is formed by applying a magnetic field. The magnetizable particles are oriented along the lines of the magnetic field.

By crossing a ferrite material, the magnetic field tends to spread uniformly over the surface of the frying pan. The decoration is no longer visible as it is also uniform.

The use of high power magnets (magnetic field higher than 0.2 T, which is variable depending on the size of the article in ferritic material) or the application of a magnetic field of similar shape but of inverted polarity on either side of the article to be decorated, makes it possible to obtain a decoration on this type of magnetizable material.

The heating article 1 may comprise a continuous or discontinuous hard base layer, covering the surface 3 of the support 2 (not represented on the figs.). The hard base layer is covered by the non-stick coating 4 which forms the outer layer of the heating article 1.

According to a first embodiment of the heating article with a hard base layer, the latter is a rough enamel layer containing less than 50 ppm lead and less than 50 ppm cadmium and having the following characteristics:
a hardness greater than that of the metal or metal alloy constituting the support 2,
a melting point ranging between that of the metal or metal alloy constituting the support 2 and that of the sintered resin(s) of the non-stick coating 4, and
a surface roughness Ra ranging between 2 and 20 μm.

According to a second embodiment of the heating article with a hard base layer, the latter is made of a ceramic and/or metal and/or polymeric material.

The non-stick coating 4 may comprise at least one layer of primer base 8,8′ comprising fluorocarbon resin and, if possible, bonding resin, mineral or organic fillers and/or pigments. The layer(s) of primer base 8, 8′ is/are covered by at least one fluorocarbon resin based sintered layer 5, 5′ further comprise a mixture of magnetizable particles 50 and non-magnetizable particles 51.

In the embodiment represented on FIG. 4, the heating article 1 comprises a support 2 covered with a nonstick coating 4 comprising two successive layers of primer base 8, 8′, which are themselves covered by two sintered fluorocarbon resin based finishing layers 5, 5′ further comprising a mixture of magnetizable particles 50 and non-magnetizable particles 51. The chemical composition of these layers may be different.

The two sintered fluorocarbon resin based layers 5, 5′ may comprise different contents of magnetizable particles and non-magnetizable particles. By way of example, the first sintered fluorocarbon resin based layer 5 comprises a greater proportion of mixture of magnetizable particles and non-magnetizable particles than the second sintered fluorocarbon resin based layer 5′.

Other positioning of sintered fluorocarbon resin based layers are also possible.

Alternatively, the non-stick coating 4 may comprise at least one pattern which comprises a thermochromic pigment composition with at least one thermochromic SC pigment, such as to form a colored temperature indicator (for example that commercialized by TEFAL under the brand name “THERMOSPOT®”). This pattern which comprises a thermochromic pigment composition with at least one thermochromic semiconductor (SC) pigment is formed in one of the sintered fluorocarbon resin based layers 5, 5′.

By thermochromic pigment composition, is meant according to the present invention, a substance, mixture or composition that changes color according to the temperature in a manner which is reversible.

The decoration is obtained after applying a magnetic field. This magnetic field may be applied while pulverizing the layers, or after pulverizing the layers. However, it is advantageously applied after the application of the finishing layers (but before curing).

The magnetic field can be achieved by means of permanent magnets or electromagnets such as to obtain the required decoration. The possible shapes are endless. The use of several separate magnets makes it possible to obtain original and/or of different intensities and/or blurred decorations.

In the example of FIG. 2, the decoration C is obtained by means of separate magnets.

FIG. 5 represents a series of six images 5.1 to 5.62 of scanning electron microscopy (SEM) of a cross-section of the frying pan 1 illustrated on FIG. 3 achieved at an area B where the lines of the magnetic field are perpendicular to the support.

In this area B, the magnetizable particles tend to become oriented along the field lines that are perpendicular to the support. FIGS. 5.1 to 5.6 (micrographic cross-sections) show that the magnetizable particles are inclined at an angle α with respect to the surface of the support 2, which in these figs. ranges between 45 and 75°: the presence of non-magnetizable particles disrupts the alignment of the magnetizable particles according to the orientation of the field lines (angle α of 90°): the orientation of the magnetizable particles according to an angle ranging between and 75° prevents the protrusion of the particles thus limiting their perception (visibility).

FIG. 6 shows a series of six images 6.1 to 6.6 of scanning electron microscopy (SEM) of a cross-section of the frying pan illustrated in FIG. 3 realized at an area A where the lines of the magnetic field are parallel with the support.

In this area A, the magnetizable particles are oriented along the field lines that are parallel with the support.

FIGS. 6.1 to 6.6 (micrographic cross-sections) show that the magnetizable particles are inclined at an angle α with respect to the support surface 2 which ranges between 0 and 20°. This orientation gives the particles good visibility.

The combination of juxtaposed high and low visibility areas contributes in giving a relief effect to the decoration.

### EXAMPLES

### Products

### Supports:

aluminum supports of a diameter of 26 cm degreased and sanded on both its main sides and having a measured arithmetic mean roughness, Ra ranging between 4 and 6 μm,
smooth aluminum supports of a diameter of 26 cm, simply degreased,
anodized aluminum supports (via a hard somewhat or not caulked anodization (that is to say, with an open porosity) and having a diameter of 26 cm,
stainless steel supports of a diameter of 26 cm, sanded on their inner side and having a measured arithmetic mean roughness, Ra ranging between 2 and 5 μm.

### Primer Composition

PTFE dispersion with 58% of dry matter commercialized under trade name TF 5035Z TF by the Dyneon company,
dispersion of carbon black at 25% of dry matter commercialized under trade name DERUSSOL by the Huntsmann company,
solubilized PAI (molecular weight 38000 g with 9.5% dry matter in a mixture of water/NMP 3/1 in weight) alkylphenol ethoxylate by way of non-ionic surfactant,
colloidal silica commercialized under trade name LUDOX AM 30 by the GRACE DAVISON company: it is a colloidal silica non modified on the surface with a specific surface of around 220 m²/g and in the form of an aqueous dispersion with dry matter of 30%.

### Finishing Compositions

PTFE dispersion with 58% dry matter with a particle size of 220 nm, commercialized under trade name TF 5035Z by the Dyneon company,
PTFE dispersion with 60% dry matter with a particle size of 290 nm, commercialized under trade name Polyflon™ D410 by the Daikin company,
PFA dispersion with 50% dry matter with a particle size of 90 nm, commercialized under trade name PFA 6910Z by the Dyneon company,
PTFE powder commercialized under reference TF9207 by the Dyneon company with a particle size of 4 μm and having a specific surface BET of 17 m2/g and a melt flow index MFR of 6 g/10 min,
magnetizable iron particles having a diameter D50 of the order of 18 μm and a diameter D90 of the order of 28 μm, these particles being commercialized under trade name STAPA® TA FERRICON 200 by the ECKART company,
lamellar non-magnetizable mica particles with a diameter of D90˜6 μm commercialized under trade name IRIODIN® 111 by the MERCK company,
weakly magnetized particles of mica or iron oxide with a D50 diameter ranging between 18 and 23 μm and a D90 diameter of the order of 43 μm, commercialized under trade name COLORONA BLACKSTAR BLUE by the MERCK company,
Polyethoxylated alkylphenol by way of non-ionic surfactant commercialized under name Triton X100
xylene by way of solvent,
oleic acid by way wetting agent,
triethanolamine as pH regulator,
polypropylene glycol by way of co-solvent,
Polyethersulfone in the form of flakes commercialized under name ULTRASON® by the BASF company,
NEP (solvent),
silicone spreading agent commercialized under name PA 56 by the DOW CORNING company.

### Tests

### Evaluation of Anti-Adhesion Maintenance During an Abrasion-Resistant Evaluation Test

In this test, an anti-adhesion test of the burnt milk type is combined with an abrasion-resistant test.

The quantitative evaluation of anti-adhesion maintenance (by evaluating the rate of anti-adhesion loss) during this test is carried out in practice by adding up the anti-adhesion ratings obtained by the burnt milk test after each series of 1000 successive passages with a green abrasive pad of SCOTCH BRITE type (registered trademark), within the limits of either the appearance of the first scratch (corresponding to the appearance of the metal constituting the support), or through the obtention of a total loss of the coating anti-adhesion. To the sum of these quotations, hereinafter referenced by S in the rating scale hereinafter, corresponds a performance rating.

By means of the burnt milk test, the anti-adhesion loss of the coating is evaluated based on the more or less easy cleaning of the burnt milk. The rating is as follows:

100: means that the film of burnt milk is completely removed by merely applying a jet of water from the kitchen tap;
50: means that a circular motion must also be carried out on the object under the water jet in order to completely detach the burnt film;
25: means that a 10 minute soak is necessary and possibly also forcing the departure by wiping with a wet sponge to remove the film entirely;
0: means that following the previous process, all or part of the burnt film remains stuck on.

Furthermore, the homogeneity of the non-stick coating is also observed, considering that, when the latter is heterogeneous (that is to say when the coating comprises areas where the anti-adhesion is good, alternating with areas where the anti-adhesion is poor), the rating which is thus given for anti-adhesion is that of the area of the coating where the anti-adhesion is at its worst.

The overall performance of this test is hence given by the following rating:

0: corresponds to S=0 meaning that there is a total loss of anti-adhesion;
1: corresponds to S ranging between 1 and 250 meaning that there is a very rapid loss of anti-adhesion during the test;
2: corresponds to S ranging between 251 and 500 meaning that there is a rapid loss of anti-adhesion during the test;
3: corresponds to S ranging between 501 and 1000, meaning that there is a loss of anti-adhesion at a moderate speed during the test;
4: corresponds to S ranging between 1001 and 1500 meaning that there is a slow loss of anti-adhesion during the test;
5: corresponds to S higher than or equal to 1501 meaning that there is a very slow loss of anti-adhesion during the test.
Evaluation of Performance with Respect to Aging

The resistance of a non-stick coating is evaluated on a support of anodized aluminum or not or of stainless steel by means of a use test to simulate the aging of the article after a period of 3 years.

The test used in the examples below is based on repeated and intensive cooking of various foods (potatoes, beans, steak, pork ribs and pancakes) known for their specific aggressiveness.

On a regular basis during this use test, anti-adhesion is evaluated by means of the egg test in accordance with standard D 21-511, as follows:
the inner side of a culinary article is oiled with a vegetable oil using a soft fabric, with a quantity of oil of the order of 2 cm³ of oil for a frying pan of a diameter between 240 mm and 280 mm;
then the article is cleaned with hot water containing washing liquid, then rinsed first with warm water and then with cold water, and is finally dried;
then the adhesion resistance of an egg cooked in the frying pan is controlled by proceeding as follows:
   the frying pan is placed on a hot plate such that its inner surface is heated to a temperature ranging between 150° C. and 170° C.;
   an egg is cracked and cooked in the center of the frying pan without adding fat, during 8 to 9 minutes;
   when the egg is cooked, it is removed with a spatula;
   then the pan is left to cool at ambient temperature; and
   the pan is cleaned using a damp sponge.

The anti-adhesion properties are related to the ease with which it is possible to remove the egg residue, in accordance with the previous operations and according to the following value scale:
100 points are assigned if the whole egg comes unstuck with a mere shake of the handle,
50 points are assigned if the whole egg comes unstuck with a spatula without leaving any residue,
25 points are assigned if the egg residue is removed by rubbing with a damp sponge,
0 points are assigned if the egg residue is not removed with the damp sponge.

### Preparation of a Primer Composition CPI

A composition of primer base CP1 is realized with the following compounds, their respective quantities being indicated in g per 100 g of composition:

### Primer Composition CPI:

PFA (50% dry matter): 9, 1 g
PTFE dispersion (60% dry matter): 22.6 g
Carbon black dispersion (25% dry matter): 4.1 g
PAI in aqueous phase+solvent (NMP)(9.5% dry matter): 43.4 g
alkylphenol ethoxylate (13%): 2.1 g
Colloidal silica (30% dry): 6.2 g
NH₄OH (d=0.9): 0.2 g

### Water: 12.3 g

### Total: 100 g

### Preparation of Finishing Compositions

By way of comparison, a finishing composition CFC1 exempt of non-magnetized particles is realized, comprising the following compounds, their respective quantities being indicated in g per 100 g of composition:

### Finishing Composition of CFCl:

PTFE dispersion at 58% dry matter
(size of particles 220 nm): 85.4 g
alkylphenol ethoxylate: 0.3 g
xylene: 3 g
oleic acid: 0.1 g
triethanolamine: 0.2 g
magnetizable particles: 1 g
water: 9 g
monopropylene glycol: 1 g

### Total: 100 g

Then, seven finishing compositions are realized according to the invention CF2 to CF8 particularly comprising a mixture of magnetizable particles and non-magnetizable particles, whereof the different components with their respective quantities are indicated herebelow in g per 100 g of composition:

Finishing composition CF2:
PTFE dispersion at 58% dry matter
(size of particles 220 nm): 85.4 g
alkylphenol ethoxylate: 0.3 g
xylene: 3 g
oleic acid: 0.1 g
triethanolamine: 0.2 g
magnetizable particles: 0.83 g
non-magnetizable particles (size of particles D90˜6 μm): 0.17 g
water: 9 g
monopropylene glycol: 1 g

### Total: 100 g

The finishing composition CF3 differs from composition CF2 by the weight ratio of the magnetizable particles on the total of magnetizable particles and non-magnetizable particles by 33% instead of 17% for CF2

### Finishing Composition CF3:

PTFE dispersion at 58% dry matter
(size of particles 220 nm): 85.4 g
alkylphenol ethoxylate: 0.3 g
xylene: 3 g
oleic acid: 0.1 g
triethanolamine: 0.2 g
magnetizable particles: 0.67 g
non-magnetizable particles (size of particles D90˜6 μm): 0.33 g
water: 9 g
monopropylene glycol: 1 g

### Total: 100 g

The finishing composition CF4 differs from composition CF2 on the one hand by the weight ratio of the magnetizable particles on the total of magnetizable particles and non-magnetizable particles by 25% instead of 17% for CF2, and on the other hand by the diameter of non-magnetizable particles.

### Finishing Composition CF4:

PTFE dispersion at 58% dry matter
(size of particles 220 nm): 85.4 g
alkylphenol ethoxylate: 0.3 g
xylene: 3 g
oleic acid: 0.1 g
triethanolamine: 0.2 g
magnetizable particles: 0.75 g
non-magnetizable particles (size of particles D90˜43 μm): 0.25 g
water: 9 g
monopropylene glycol: 1 g

### Total: 100 g

The finishing composition CF5 differs from composition CF4 by the mixture of PTFE and PFA dispersions replacing, in equal quantity, the PTFE dispersion of composition CF4.

### Finishing Composition CF5:

PTFE dispersion at 58% dry matter
(size of particles 220 nm): 42.7 g
PFA dispersion at 58%
of dry matter (size of particles 90 nm): 42.7 g
alkylphenol ethoxylate: 0.3 g
xylene: 3 g
oleic acid: 0.1 g
triethanolamine: 0.2 g
magnetizable particles: 0.75 g
non-magnetizable particles (size of particles D90˜43 μm): 0.25 g
water: 9 g
monopropylene glycol: 1 g

### Total: 100 g

The finishing composition of CF6 differs from composition CF5 by adding PTFE powder at 100% dry matter to the PTFE dispersion.

### Finishing Composition CF6:

PTFE dispersion at 58% dry matter
(size of particles 220 nm): 42.8 g
PTFE powder at 100% dry matter: 4.3 g
PFA dispersion at 58% dry matter
(size of particles 90 nm): 38.4 g
alkylphenol ethoxylate: 0.3 g
xylene: 3 g
oleic acid: 0.1 g
triethanolamine: 0.2 g
magnetizable particles: 0.75 g
non-magnetizable particles (size of particles D90˜43 μm): 0.25 g
water: 9 g
monopropylene glycol: 1 g

### Total: 100 g

The finishing composition CF7 mainly differs from composition CF6 by the total replacement of the PTFE dispersion by PTFE powder at 100% dry matter and the presence of polyethersulfone.

### Finishing Composition CF7:

PTFE powder at 100% dry matter: 12 g
polyethersulfone in pellets: 12 g
NEP (solvent): 65 g
xylene: 8 g
Silicone spreading agent PA56: 2 g
magnetizable particles: 0.75 g
non-magnetizable particles (size of particles D90˜43 μm): 0.25 g
water: 9 g
monopropylene glycol: 1 g

### Total: 100 g

### Realization of Non-Stick Coatings on Aluminum Supports

One of the sides of an aluminum support is typically coated with the composition CP1 to form a wet primer layer and then one of the finishing compositions CFC1 (comparative example), and CF2 to CF7 (examples according to invention) on the wet primer layer to form a finishing layer.

Then a magnetic field is applied by means of a permanent magnet having a magnetic power ranging between 50 and 100 mT, which leads to the orientation of the magnetic particles to form a three dimensional decoration in the finishing layer.

Finally, the thus coated support is then cured at a temperature of 415° C.

The thus coated supports are then subjected to the series of aforementioned tests of the present application.

The results obtained following these different tests are gathered in results table 1 below.

In this table, example 1 corresponds to a non-stick coating, whereof the finishing composition is the CFC1 composition, and examples 2 to 7 respectively correspond to a non-stick coating, whereof the finishing composition is one of the compositions CF2 to CF7, respectively (that is to say, example 2 corresponds to a finishing layer CF2 and the example 7 to a finishing layer CF7).

### Realization of Non-Stick Coatings on Anodized Aluminum Supports

We proceed in the same manner as before with aluminum supports, but by changing the nature thereof: an anodized aluminum support is used here instead of an aluminum support and for the realization of the non-stick coating, only the primer composition CP1 and the finishing compositions CF3 and CF4 are used.

The supports coated in accordance with the method of the invention are then subjected to the series of aforementioned tests in the present application.

The results obtained following these different tests are gathered in examples 3′ and 4′ in table 1 of the following results table: these examples 3′ and 4′ are identical to examples 3 and 4 respectively, except for the nature of the support, which is here anodized aluminum instead of aluminum.

### Realization of Non-Stick Coatings on Ferritic Stainless Steel Supports

We proceed in the same manner as before with supports in anodized aluminum or not, but with a support of ferritic stainless steel. For the realization of the non-stick coating, only the primer composition CP1 and the finishing composition CF3 are used.

The magnetic field is generated by an electromagnet making it possible to obtain a value of 0.2 T

The support coated in accordance with the method of the invention is then subjected to the series of aforementioned tests in the present application.

The results obtained following these different tests are gathered in the example 3″ in the results table 1 hereinafter: this example 3″ is identical to examples 3 and 3′, except for the nature of the support, which is here of ferritic stainless steel instead of anodized aluminum (example 3′) or not (example 3).

TABLE 1

| | | | | Evaluation of anti-adhesion maintenance | |
|---|---|---|---|---|---|
| | | | | during an abrasion-resistant test | |
| | Nature of | Presence of | | | Anti-adhesion homogeneity |
| examples | support | non-magnetizable particles | Aging test | Rating | of the coating |
| 1 | Aluminum | No | 0 | 0 | No |
| 2 | Aluminum | Yes | 25 | 3 | Yes |
| 3 | Aluminum | Yes | 50 | 4 | Yes |
| 3′ | anodized aluminum | Yes | 100 | 5 | Yes |
| 3″ | Stainless steel | Yes | 50 | 4 | Yes |
| 4 | Aluminum | Yes | 50 | 3 | Yes |
| 4′ | anodized aluminum | Yes | 50 | 4 | Yes |
| 5 | Aluminum | Yes | 50 | 3 | Yes |
| 6 | Aluminum | Yes | 50 | 3 | Yes |
| 7 | Aluminum. | Yes | 25 | 2 | Yes |

1. A heating article comprising a support intended to be heated, said support comprising a surface covered by a non-stick coating said non-stick coating comprising at least a fluorocarbon resin based sintered layer forming a continuous network, characterized in that said sintered layer further comprises a mixture of magnetizable particles and non-magnetizable particles, part of said magnetizable particles being inclined at an angle α with respect to the surface of the support and the other magnetizable particles being substantially parallel to the support such as to form a three-dimensional decoration.

2. The heating article according to claim 1, wherein the angle of inclination α of a part of the magnetizable particles ranges between 20° and 89°.

3. The heating article according to claim 1, wherein the angle of inclination α of a part of the magnetizable particles ranges between 45° and 89°.

4. The heating article according to claim 1, wherein the mixture of magnetizable particles and non-magnetizable particles represents between 1% and 5% in weight of the weight of the fluorocarbon resin based sintered layer.

5. The heating article according to claim 4, wherein the mixture of magnetizable particles and non-magnetizable particles represents between 2% and 3% in weight of the weight of the fluorocarbon resin based sintered layer.

6. The heating article according to claim 1, wherein the percentage of non-magnetizable particles in the mixture of magnetizable particles and non-magnetizable particles ranges between 15% and 40% in weight with respect to the total weight of the mixture of magnetizable particles and non-magnetizable particles.

7. The heating article according to claim 1, wherein the magnetizable particles exhibit a dimension D50 less than or equal to 23 μm.

8. The heating article according to claim 1, wherein the non-magnetizable particles exhibit a dimension D90 ranging between 20% and 250% of the dimension of the magnetizable particles.

9. The heating article according to claim 1, wherein the magnetizable particles and non-magnetizable particles are in the form of flakes.

10. The heating article according to claim 1, wherein one or both of the magnetizable particles and non-magnetizable particles are colored on the surface.

11. The heating article according to claim 10, wherein one or both of the magnetizable particles and the non-magnetizable particles exhibit a core-shell structure.

12. The heating article according to claim 1, wherein the non-magnetizable particles are constituted of mica, aluminum or titanium dioxide coated mica.

13. The heating article according to claim 1, wherein the magnetizable particles are constituted of iron, iron oxide, iron coated aluminum, or iron coated mica, the iron in a ferritic form.

14. The heating article according to claim 1, wherein the sintered layer comprises a single fluorocarbon resin or a mixture of fluorocarbon resins, alone or in a mixture with other heat-stable resins.

15. The heating article according to claim 14, wherein the fluorocarbon resin is chosen from among the polytetrafluoroethylene (PTFE), copolymer of tetrafluoroethylene and perfluoro propyl vinyl ether (PFA), and the copolymer of tetrafluoroethylene and hexafluoropropylene (FEP), and combinations thereof.

16. The heating article according to claim 1, wherein the heating article comprises a hard base layer, continuous or discontinuous covering said surface of the support said hard base layer being covered by said non-stick coating.

17. The heating article according to claim 16, wherein the hard base is a rough enamel layer having the following characteristics:
a hardness greater than that of the metal or metal alloy constituting the support,
a melting point ranging between that of the metal or the metal alloy constituting the support and that of the sintered resin(s) of the non-stick coating, and
a surface roughness Ra ranging between 2 μm and 20 μm.

18. The heating article according to claim 16, wherein the hard base layer is made of a ceramic and/or metal and/or polymeric material.

19. The heating article according to claim 1, wherein the non-stick coating comprises:
at least a layer of primer base comprising fluorocarbon resin and, optionally, one or more of bonding resin, mineral or organic fillers and/or pigments, and
at least a sintered fluorocarbon resin based finishing layer, covering said layer of primer base and further comprising a mixture of magnetizable and non-magnetizable particles.

20. The heating article according to claim 1, wherein the non-stick coating comprises at least a pattern which comprises a thermochromic pigment composition with at least one thermochromic SC pigment.

21. A method for manufacturing a heating article comprising a support intended to be heated, said method comprising the following steps:
preparing at least a composition based on at least one fluorocarbon resin in particulate form, said fluorocarbon resin, being either alone or in a mixture with a heat stable bonding resin and resistant to at least 200° C.,
applying said composition on a surface of said support to form a fluorocarbon resin layer;
curing said heating article thus coated by said fluorocarbon resin layer comprising a three dimensional decoration at a temperature ranging between 350° C. and 450° C. to sinter said layer such as to obtain a sintered fluorocarbon resin based layer forming a continuous network; and
wherein said fluorocarbon resin based composition further comprises a mixture of magnetizable particles and non-magnetizable particles, and a magnetic field being applied in the fluorocarbon resin layer, before the curing step, such as to orient a part of the magnetic particles to form a three dimensional decoration in said layer.

22. The method according to claim 21, wherein the application of the magnetic field is conducted after the application of the fluorocarbon resin based composition and before the curing step.

23. The method according to claim 21, wherein the fluorocarbon resin based composition comprises fluorocarbon resin particles having a dimension lower than or equal to 5 μm.

24. The method according to claim 23, wherein the fluorocarbon resin particles have a dimension ranging between 90 nm and 300 nm.
